(19) United States
(12) Patent Application Publication
(10) Pub. No.: US 2007/0039694 A1
(43) Pub. Date: Feb. 22, 2007

(54) Method for producing rfid labels

(76) Inventors: Thomas Walther, Hofheim (DE); Edgar Werber, Offenbach (DE); Bernd Lomp, Grundau (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/566,594

(22) PCT Filed: Jul. 21, 2004
(86) PCT No.: PCT/EP04/08126

§ 371 Date: Mar. 14, 2006

(30) Foreign Application Priority Data
Aug. 1, 2003 (DE) 103 35 230.9

(51) Int. Cl. B32B 37/00; H01Q 1/36

(52) U.S. Cl. 156/579; 340/572.8; 343/895

(57) ABSTRACT

A method is described for producing an RFID label using a printing process. The required parts are applied to the label in a simple way and preferably also to protect the antenna against mechanical or chemical damage. At least parts of the antenna and the tuned circuit which are required for functioning of the RFID label are applied to the printing material by sheet-fed offset printing or, directly or indirectly, by way of a relief printing plate.

The invention relates to a method for producing RFID labels, according to the precharacterizing clause of claim 1.

### PRIOR ART

The invention describes different methods for producing RFID (Radio Frequency IDentification) labels, also called smart labels. The basis of the intelligent labels (RFID, smart labels) is what is known as transponder technology. Their great advantage lies in the radio link between the label and a reader. This can accelerate the data acquisition process by machine to an extreme extent, because the readers no longer need an optical link to the labels. In this way, for example, the contents of a box or an entire pallet can be detected without error. Security codes can also be stored in the intelligent labels, as a result of which falsified packets (for example, pharmaceutical industry) or thefts can be identified unambiguously.

A system for wireless identification comprises two components: the RFID labels (smart labels) which are attached to the goods, and the writer/reader with which data can be read from or transferred to the label. Depending on the design, the transponders store simple identification numbers or up to as much as complex data (for example, expiry date, place and date of production, retail price, etc.). Measured data can also be stored. The transponders usually comprise an integrated circuit, an antenna and further passive components. A distinction is made in the type of energy supply between active and passive transponders. If the label has an energy supply, for example in the form of a battery, it is called an active system. A transponder is called passive if it is supplied with energy via an external, magnetic or electric field.

The transponder IC which is connected to the antenna of the mobile data carrier is responsible for transmitting/receiving the data. In passive RFID transponders, the entire intelligence and functionality is integrated in this circuit as a rule.

Beyond this, some types comprise an on chip resonance capacitor for the tuned circuit, with the result that no further external components are required apart from an antenna coil. The required capacitor or capacitors can also be produced by printing processes. Classic and known methods for producing RFID labels are lamination of a coated foil onto the label, printing the antenna by means of screen printing processes, or production by means of inkjet processes.

### OBJECT OF THE INVENTION

It is an object of the present invention to apply the required parts to the label in a simple way and preferably also to protect the antenna against mechanical or chemical damage.

This object is achieved by the characterizing features of claims 1 and 12. Developments of the invention result from the respective subclaims.

### EXAMPLES

According to the invention, there is provision for at least parts of the antenna which is required for functioning and of the tuned circuit to be applied to the printing material by sheet-fed offset printing, or for at least part of the antenna which is required for functioning and of the tuned circuit to be applied, directly or indirectly, by way of a relief printing plate. After printing, all that remains is for the chip which is usually not in a housing to be applied by an adhesive bonding or soldering process.

The following variables are of interest during design of the antenna: the inductance, the coil area, the ohmic resistance and the coupling capacitance between the turns. Deviations from the characteristic values can lead to the contact not being established between the writer/reader and the transponder. The resonant frequency has to be achieved with high quality, with the result that very high demands are made of the printing quality.

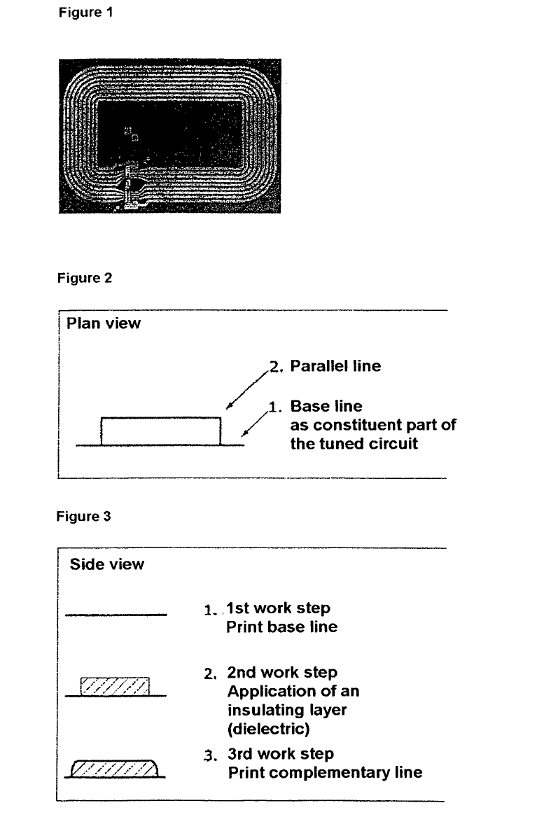

According to the invention, a metallic ink or conductive paste is transferred onto the printing material within a sheet-fed or web-fed offset printing press via a waterless offset plate or a wet offset plate via the rubber blanket. The printed lines form the antenna and optionally the entire tuned circuit; if required, the chip is later soldered or adhesively bonded onto it. The printing material on which the constituent parts of the tuned circuit are printed can be a fibrous material (paper, nonwoven inter alia), a woven fabric made from natural and/or synthetic fibers, or a plastic film. FIG. 1 shows a plan view of a label which has been produced according to the invention.

An absorbent printing material, for example if it is a paper or another fibrous material, can be pretreated, in order to avoid penetration of the conductive printing ink or paste. The pretreatment can be an application of varnish or an application of a preprinting ink via a flexographic printing unit or an offset printing unit. It is also possible for a film to be laminated onto the rear of the label or for the rear of the label to have already been pretreated by the manufacturer. Very pronounced penetration of the printing ink into the printing material can result in a change in the inductance as a result of the third plane. Application by means of a printing plate for waterless printing is preferred to wet offset printing, as the damping solution which is required in wet offset printing can lead to corrosion of the ink and the precision of the printing is also higher. Higher resolutions and finer line thicknesses can also be printed by waterless offset printing.

A capacitor which is required for producing a tuned circuit can be produced by two lines being printed closely next to one another (FIG. 2), which lines are connected to one another at the ends of the shorter line. As an alternative, the base line can be printed first, then an insulating material is printed over it and, in a third printing unit, the complementary line is then printed (FIG. 3). The capacitor can also be integrated into the chip. Other circuit elements can also be printed, for example resistances by means of a reduction in the line thickness.

Theoretically, the capacitor lines can be printed so as to lie opposite one another on both sides of the printing material. To this end, the printing material would have to be perforated first, in order that a connection is produced during the ink application between two lines which lie opposite one another.

Subsequently, the antenna and the tuned circuit can be covered with a protective varnish which protects the print against mechanical, chemical or oxidative damage. As an alternative, a protective film can be applied.

In a second method, an adhesive is preprinted via a printing unit which brings sheets which have been printed with the adhesive into contact with a transfer film which is coated with a metallic material or another conductive material. The conductive material is detached from the transfer film at those locations having the applied adhesive and is transferred onto the printing material. Said conductive material then forms the tuned circuit, antenna or constituent parts of them.

Application of the lines of the antenna/the tuned circuit by means of the flexographic printing process may be suitable as a third method. However, it is disadvantageous that a flexographic printing plate can lead to pinched edges if the positioning has not been adjusted exactly. Said pinched edges would lead to a change as a result of a capacitance change and to a change in the characteristics of the tuned circuit.

1.-24. (canceled)

25. A method for producing an RFID label using a printing process, comprising the step of applying at least parts of an antenna and a tuned circuit required for functioning of the RFID label by printing conductor tracks on a printing material by sheet-fed offset printing.

26. The method of claim 25, wherein a conductive paste or a conductive printing ink is used for printing the conductor tracks.

27. The method of claim 25, wherein conductive printing ink having metallic particles is used for printing the conductor tracks.

28. The method of claim 25, wherein conductive printing ink having carbon black or carbon fibers is used for printing the conductor tracks.

29. The method of claim 25, wherein the conductor tracks are applied in a sheet-fed offset press having a gripper transport means.

30. The method of claim 25, wherein the conductor tracks are applied within a web-fed offset press.

31. The method of claim 29, wherein said step of applying comprises applying the parts of the antenna and the tuned circuit to a rear side of the printing material, and subsequently turning the printing material over in a turner device.

32. The method of claim 25, further comprising the step of applying a protective varnish or a protective ink to the printing material after the parts of the antenna and the tuned circuit are applied to the printing material.

33. The method of claim 32, wherein the protective varnish or the protective ink is applied using the sheet-fed offset printing method.

34. The method of claim 25, further comprising the step of applying a protective varnish to the printing material after the parts of the antenna and the tuned circuit are applied to the printing material, wherein the protective varnish is applied using a flexographic printing unit having a chamber type doctor and an engraved roll.

35. The method of claim 25, further comprising the step of applying a protective varnish to the printing material after the parts of the antenna and the tuned circuit are applied to the printing material, wherein the protective varnish is applied via a two-roll flexographic printing unit.

36. The method of claim 25, wherein the printing material is a fibrous material.

37. The method of claim 25, wherein the printing material is a film.

38. The method of claim 25, wherein the printing material is a woven fabric made from at least one of natural and synthetic fibers.

39. The method of claim 25, wherein the printing material is an absorbent printing material, the method further comprising one of precoating, prevarnishing or preprinting the printing materials with a varnish or a preprinting ink to reduce absorption properties of the printing material.

40. The method of claim 39, wherein the step of precoating, prevarnishing or preprinting is performed by a direct letterpress printing unit.

41. The method of claim 39, wherein the step of precoating, prevarnishing or preprinting includes indirectly applying the varnish or ink using a relief printing plate and a rubber-covered cylinder.

42. The method of claim 39, wherein the step of precoating, prevarnishing or preprinting includes applying the varnish or ink using an offset printing unit.

43. The method of claim 25, further comprising the step of printing two lines next to one another over a distance to produce a capacitive element, the lines being connected to one another at the ends of a shorter line of the two lines.

44. The method of claim 25, further comprising the step of producing a capacitive element by printing a base line on the printing material, printing an insulator, and printing a complementary line on the insulator so that the insulator is arranged between the base line and the complementary line.

45. A method for producing an RFID label using a printing process, comprising the step of applying at least parts of an antenna and a tuned circuit required for functioning of the RFID label by printing conductor tracks on a printing material, directly or indirectly, using a relief printing plate.

46. The method of claim 45, wherein the relief printing plate is clamped onto a plate cylinder of a sheet-fed printing press or web-fed printing press and the conductor tracks are printed by applying ink to the printing material indirectly by a rubber-covered cylinder.

47. The method of claim 46, wherein the relief printing plate is used in a printing press which also comprises offset printing units.

48. The method of claim 45, wherein the relief printing plate is in direct contact with the printing material in a sheet-fed or web-fed printing press.

49. The method of claim 48, wherein the relief printing plate is used in a printing press which also comprises offset printing units.

50. The method of claim 45, wherein the printing material is a fibrous material.

51. The method of claim 45, wherein the printing material is a film.

52. The method of claim 45, wherein the printing material is a woven fabric made from at least one of natural and synthetic fibers.

53. The method of claim 45, wherein the printing material is an absorbent printing material, the method further comprising one of precoating, prevarnishing or preprinting the printing materials with a varnish or a preprinting ink to reduce absorption properties of the printing material.

54. The method of claim 53, wherein the step of precoating, prevarnishing or preprinting is performed by a direct letterpress printing unit.

55. The method of claim 53, wherein the step of precoating, prevarnishing or preprinting includes indirectly applying the varnish or ink using a relief printing plate and a rubber-covered cylinder.

56. The method of claim 53, wherein the step of precoating, prevarnishing or preprinting includes applying the varnish or ink using an offset printing unit.

57. The method of claim 45, further comprising the step of printing two lines next to one another over a distance to produce a capacitive element, the lines being connected to one another at the ends of a shorter line of the two lines.

58. The method of claim 45, further comprising the step of producing a capacitive element by printing a base line on the printing material, printing an insulator, and printing a complementary line on the insulator so that the insulator is arranged between the base line and the complementary line.
